(19) United States
(12) Patent Application Publication
(10) Pub. No.: US 2023/0366580 A1
(43) Pub. Date: Nov. 16, 2023

(54) SYSTEMS AND METHODS FOR CONTROLLING AIR QUALITY IN HVAC SYSTEMS

(71) Applicants: Jason BOWMAN, Lancaster, PA (US); Kathryn Grace STROH, Lancaster, PA (US)

(72) Inventors: Jason BOWMAN, Lancaster, PA (US); Kathryn Grace STROH, Lancaster, PA (US)

(21) Appl. No.: 18/195,154

(22) Filed: May 9, 2023

Related U.S. Application Data
(60) Provisional application No. 63/341,084, filed on May 12, 2022.

(51) Int. Cl. F24F 11/63

(52) U.S. Cl. CPC F24F 11/63; F24F 2110/64

(57) ABSTRACT

An air quality control system for an HVAC system includes a particulate matter sensor for sensing particulates of outside air entering a building, a gas matter sensor for sensing a concentration level of certain types of gases present in the outside air, a fresh air damper configured to operate based on at least one of the particulate matter sensor or the gas matter sensor, and a controller communicatively coupled to the particulate matter sensor, the gas matter sensor and the fresh air damper. The controller can be configured to receive information associated with a level of particulates of the outside air from the particulate matter sensor, receive information associate with a level of concentration level of certain types of gases from the gas matter sensor, and generate a damper command to close the fresh air damper, wherein the damper command is based on at least one of the level of particulates or the level of concentration level of certain types of gases.

### RELATED APPLICATION

This application claims the benefit under 35 U.S.C. § 119(e) to U.S. Provisional Application Ser. No. 63/341,084 filed May 12, 2022, the entirety of which is incorporated herein by reference.

### TECHNICAL FIELD

The present disclosure generally relates to air quality control in an HVAC system and, more particularly, to systems and methods for improved air quality control including a sensing module(s) in an HVAC system.

### BACKGROUND

Most home heating and cooling systems, including forced air heating systems, do not mechanically bring fresh air into the house. Some conventional methods to bring in fresh air have been opening windows and doors, when the weather permits, operating window or attic fans, or running a window air conditioner with the vent control open increases the outdoor ventilation rate. Advanced designs of new commercial and residential buildings are starting to feature mechanical systems that bring outdoor air into the building. For example, some of these designs include indoor air scrubbers, HEPA filters, and UVC and ionizing particle lights within HVAC systems. However, these existing devices only filter the contaminated air, and do not sense the contaminated air and stops from its origin.

In further HVAC systems, an Energy Recovery Ventilator (ERV) can be employed, which is the energy recovery process in residential and commercial HVAC systems that exchanges the energy contained in normally exhausted air of a building or conditioned space, using it to treat (precondition) the incoming outdoor ventilation air. During the warmer seasons, an ERV system pre-cools and dehumidifies and during cooler seasons, the system humidifies and pre-heats. An ERV system helps HVAC design meet ventilation and energy standards (e.g., ASHRAE), improves indoor air quality and reduces total HVAC equipment capacity, thereby reducing energy consumption.

In addition and/or alternatively to the ERV, a Fresh Air Damper (FAD) can be employed to control the quality of air intake into the building, in which a fully energized FAD is constantly powered by its own individual circuit. Depending on the square footage of the building or space, the FAD activates a set number of times per hour to alleviate positive pressure in the building. The FAD can also be utilized to incorporate fresh air into the home depending on the homeowner's comfort needs. In commercial HVAC units, economizers reduce air conditioning costs by using outside air (OSA) for free cooling when the outdoor temperature is less than the indoor air temperature, causing the compressor to run less. This process occurs by OSA dampers closing when cooler outside air is not available. The biggest advantages of economizers are reductions in energy consumption and decreased costs of maintaining temperatures in commercial buildings. Another advantage is that air quality is improved because of increased ventilation. In other words, the same air is no longer being conditioned and recycled in a space, but rather, fresh air from outside is being used. However, the issue with these existing designs is that they do not take into consideration whether the outside air being introduced into the system is safe or toxic. For example, a homeowner has a firepit or a grill near the fresh air termination, and as the HVAC system operates to heating/cooling function and the damper opens during the operation, the system will pull in contaminated air at the fresh air termination thus, bringing smoke particulate air into the home. In another example, during dust storms along with possible wildfires, which are common in the Midwest and West Coast of the United States in the summer months, the system will pull in contaminated air, i.e., smoke particulates, into the home.

In view of the problems associated with conventional HVAC systems to control air quality entering a building, there remains a need to provide a HVAC system that prevents and/or reduces external, hazardous contaminates from entering a building when the system calls for fresh air.

### SUMMARY

In an exemplary embodiment, an air quality control system for an HVAC system includes a particulate matter sensor for sensing particulates of outside air entering a building, a gas matter sensor for sensing a concentration level of certain types of gases present in the outside air, a fresh air damper configured to operate based on at least one of the particulate matter sensor or the gas matter sensor, and a controller communicatively coupled to the particulate matter sensor, the gas matter sensor and the fresh air damper. The controller can be configured to receive information associated with a level of particulates of the outside air from the particulate matter sensor, receive information associate with a level of concentration level of certain types of gases from the gas matter sensor, and generate a damper command to close the fresh air damper, wherein the damper command is based on at least one of the level of particulates or the level of concentration level of certain types of gases.

In another exemplary embodiment, a method of controlling air quality of an HVAC system includes determining, via a particulate matter sensor, information associated with a level of particulates of outside air, determining, via a gas matter sensor, information associate with a level of concentration level of certain types of gases, and generating a damper command to close a fresh air damper, wherein the damper command is based on at least the level of particulates or the level of concentration level of certain types of gases.

In another exemplary embodiment, a method of controlling air quality of an HVAC system includes determining a level of contaminates present in outside air, determining whether the level of contaminates exceeds a threshold, and in response to determining that the level of the contaminates exceeds the threshold, closing a fresh air damper to prevent air intake of the outside air from entering the HVAC system.

Other features and advantages of the present invention will be apparent from the following more detailed description of the preferred embodiment which illustrates, by way of example, the principles of the invention.

### BRIEF DESCRIPTION OF THE DRAWINGS

FIG. 1 is a schematic block diagram of components for operating an air quality system, according to an example embodiment of the present disclosure.

FIGS. 2A-2D are schematic diagrams of a controller of the air quality system of FIG. 1, according to an example embodiment of the present disclosure.

FIG. 3A-3C are schematic circuit diagrams of components in communication of a controller, according to an example embodiment of the present disclosure.

FIG. 4 is a flowchart of an example method for controlling air quality of an HVAC system, according to an example embodiment of the present disclosure.

FIG. 5 is a flowchart of another example method for controlling air quality of an HVAC system, according to an example embodiment of the present disclosure.

It should be noted that these Figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. For example, the relative thicknesses and positioning of layers, regions and/or structural elements may be reduced or exaggerated for clarity. The use of similar or identical reference numbers in the various drawings is intended to indicate the presence of a similar or identical element or feature.

### DETAILED DESCRIPTION

The present disclosure relates to detecting hazardous external contaminates in outdoor air and preventing and/or reducing the flow of contaminated air from entering commercial and/or residential spaces. That is, the present disclosure prevents the contaminants from entering the residential or commercial spaces at its source, i.e., fresh air intake. Accordingly, the system of the present disclosure acts as a fail-safe to stop the introduction of potentially harmful outdoor air prior to the system dispersing the contaminates throughout the building in the heating and cooling process.

One implementation is to employ a fresh air damper (FAD) or an economizer, for example, to an existing HVAC system and interrupting the damper control upon detection of contaminated air, thus preventing toxic and contaminated air from entering the building. The present disclosure differs from what is currently on the market by interrupting the flow of poor air quality and potentially harmful air via the FAD/economizer. The present disclosure further focuses on monitoring the quality of outdoor air and/or indoor air and scrubbing/filtering/purifying the contaminated air after entering the dwelling. Therefore, the existing devices do not detect particulates or noxious gases as these contaminants are being introduced from the outside and prevent the harmful contaminants from entering the dwelling.

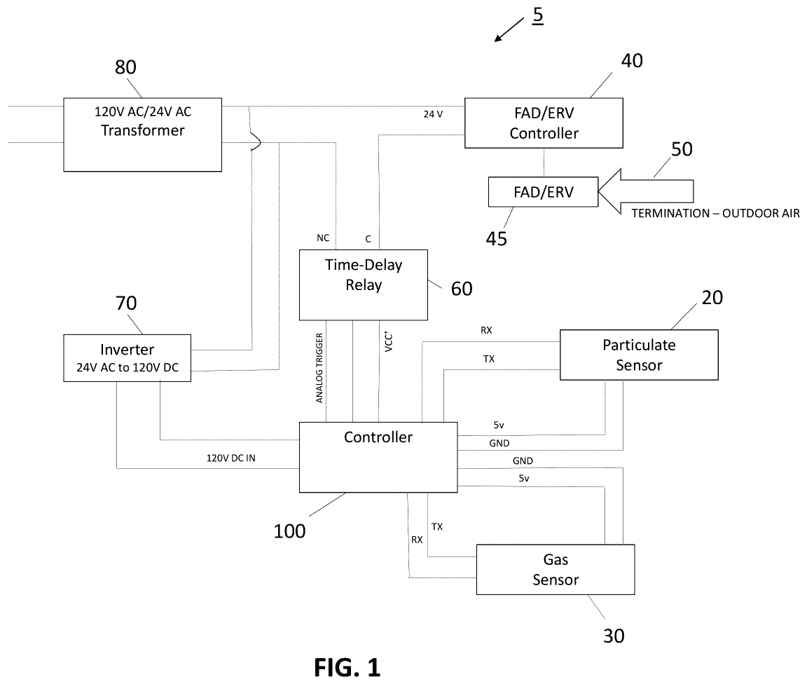

FIG. 1 illustrates a schematic view of an exemplary air quality control system 5 that may be incorporated into a HVAC system. It will be generally understood that different and/or other types of systems and/or components may be incorporated into the HVAC system, depending upon the building design and the ventilation needs of the building. In some cases, as shown, the air quality control system 5 may be located upstream of the one or more HVAC components, such as, for example, a heating and/or an air conditioning unit, but this is not required.

The air quality control system 5 can include a particulate sensor 20 to sense particulate matters of outdoor air, a gas sensor 30 to sense a type of gases present in the outdoor air, and an air damper controller 40 to operate a fresh air damper (FAD) or an economizer 45. Each of the particulate sensor 20, the gas sensor 30, and the air damper controller 40 are disposed in electrical or operative communication with a controller 100, such as a memory and processor, which is configured to integrate control of all apparatuses 20, 30, 40.

The air damper controller 40 controls the fresh air damper 45 or the economizer and is configured to close outside air from entering the building. In one implementation, the fresh air damper 45 is located near or at a fresh air termination 50 (i.e., fresh air intake) of the HVAC system. The air damper controller 40 modulates the air quality based on information of the particulate sensor 20 and/or the gas sensor 30, which will be described later in detail.

The particulate sensor 20 can be configured to detect impurities or air pollutants in outside air at or near the fresh air termination 50 of the HVAC system. In one implementation, the particulate sensor 20 is a laser diode particulate sensor that uses laser scattering to radiate suspending particles in the air, and then collects scattering light to obtain the curve of scattering light change with time. A microprocessor (not shown) within the particulate sensor 20 can calculate equivalent particle diameter and a number of particles with different diameter per unit volume. For example, when the sensor 20 recognizes 2.5-10 ppm levels, which indicate potentially hazardous air quality, the sensor 20 will send a signal to open a relay connection, and interrupt power to the air damper controller 40, thus closing the fresh air damper for a set period of time prior to resampling the air from the outdoor fresh air termination 50.

Some particulate matters (also called particle pollution) may include smoke, dust, dirt, soot, pollen, mold, etc. which can be large or dark enough to be seen with the naked eye. Other air pollution can include air pollutants, such as, for example, ozone (O₃), carbon monoxide (CO), nitrogen dioxide (NO₂), sulfur dioxide (SO₂), and lead (Pb). These types of air pollutants are called hazardous air pollutants (HAPs) (i.e., toxic air pollutants or air toxics) that are known or suspected to cause serious health problems, such as cancer. Examples of toxic air pollutants include benzene, which is found in gasoline; perchlorethlyene, which is emitted from some dry cleaning facilities; and methylene chloride, which is used as a solvent and paint stripper. Examples of other air toxics include dioxin, asbestos, toluene, and metals such as cadmium, mercury, chromium, and lead compounds.

In some implementations, a method to measure the quality of outside air is using an air quality index (AQI). The AQI is an index for reporting daily air quality. It tells how clean or polluted the air is, and what associated health effects might be of concern, especially for ground-level ozone and particle pollution. The higher the AQI value, the greater the level of air pollution and the greater the health concern. For example, an AQI value of 50 represents good air quality with little potential to affect public health, while an AQI value over 300 represents hazardous air quality.

The AQI is divided into six categories. For instance, when the AQI is 0-50, the level of health concern (air quality conditions) is good; when the AQI is 51-100, the level of health concern (air quality conditions) is moderate; when the AQI is 101-150, the level of health concern (air quality conditions) is unhealthy for sensitive groups; when the AQI is 151-200, the level of health concern (air quality conditions) is unhealthy; when the AQI is 201-300, the level of health concern (air quality conditions) is very unhealthy; and when the AQI is 301-500, the level of health concern (air quality conditions) is hazardous.

The gas sensor 30 is configured to measure a concentration level of certain types of gases that are harmful to the human body, such as, for example, carbon monoxide (CO), nitrogen dioxide (NO₂), sulfur dioxide (SO₂), propane (C₃H₈), nitric oxide (NO) and various Volatile Organic Compounds (VOC)s. The gas sensor 30 can sample outside air similarly as the particulate sensor 20; however, the gas sensor 30 utilizes a heated diode within a mechanism to detect which compounds are present within the sampled air. If levels of contamination exceed levels that are safe for human exposure, a signal will be sent to the microcontroller 100 to interrupt power to the damper controller 40, thus closing the fresh air damper for a set period of time prior to resampling the air from the outdoor fresh air termination 50. For example, if the level for carbon monoxide (CO) exceeds 70 ppm, for nitrogen dioxide (NO₂) exceeds 20 ppm, and for sulfur dioxide (SO₂) exceeds 100 ppm, the gas sensor 30 will indicate a signal that harmful air pollutants are present in the sampled air.

The controller 100 is configured to operate the FAD 45 via the damper controller 40 based upon both data received from sensors 20, 30. The controller 100 can also be controlled using user specifications. In other words, the controller 100 can be operated based upon a predetermined parameter(s) set by the user. In one implementation, the controller 100 is configured to execute control logic to control various aspects or components of the air quality control system 5. That is, data (e.g., signals provided by the particulate sensor 20 and/or the gas sensor 30) used by the controller 100 can include a damper position (i.e., closed or open) for outside air. Using this data (e.g., signals), the controller 100 is configured to determine a variety of factors to control aspects of the system, such as the FAD 45, which depends on the data received from the particulate sensor 20 and/or the gas sensor 30. For example, when the controller 100 detects a certain level of particulate matters in the outside air is beyond a threshold (e.g., AQI above 50) and/or that certain types of gases (e.g., CO, NO₂, SO₂ etc.) are present in the outside air is also beyond a threshold (e.g., above 70 ppm for CO, above 20 ppm for NO₂, above 100 ppm for SO₂), the controller 100 sends a signal to close the FAD 45, thus preventing outside air from entering the building. As such, this enables the harmful air pollutants from entering the dwelling spaces. Unlike existing systems, these systems only monitor the presence of harmful air pollutants once inside of the building and possibly operating a further function (i.e., ventilate) to expel the air in the HVAC system. The present disclosure solves this issue by preventing at the initial-onset and prevents any harmful air pollutants from entering the HVAC system.

It should be appreciated that the controller 100 illustrated by FIG. 1 is provided by way of example only. The controller 100 can be configured in a variety of ways. For example, the controller 100 can be decentralized and distributed as a local control module, such as in the FAD damper controller 40. Further, the controller 100 can distribute the execution of an algorithm implementation to different parts of the system 5 and is configured to communicate with one another as needed. In some embodiments, each particulate sensor 20 and gas sensor 30 can be controlled by a separate controller (not shown) for each corresponding apparatus, which determines the appropriate level of contaminants.

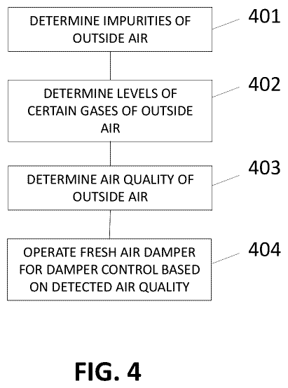

The controller 100 is configured to integrate the control of the FAD 45 based upon the data from the particulate sensor 20 and the gas sensor 30 by closing the FAD 45 from outside air entering the building while still meeting air ventilation requirements. In one arrangement, when providing such integration, the controller 100 is configured to execute the processing elements as provided in the flowchart 400, as illustrated in FIG. 4.

In step 401, the controller 100 is configured to determine impurities, i.e., smoke, dust, dirt, soot, pollen, mold, at 2.5-10 ppm levels in the outside air provided to the FAD 45 via the particulate sensor 20.

In step 402, the controller 100 is configured to determine types of gases, i.e., CO, NO₂, SO₂, are present in the outside air at above 70 ppm for CO, above 20 ppm for NO₂, above 100 ppm for SO₂, respectively, in the outside air provided to the FAD 45 via the gas sensor 30.

In step 403, based on the data from the particulate sensor 20 and the gas sensor 30, the controller 100 is able to determine the quality of the outside air. For example, if none of the thresholds for harmful determination of air quality are exceeded, the controller 100 maintains the current condition of the HVAC system at the fresh air termination.

In step 404, based on the detected air quality via the particulate sensor 20 and the gas sensor 30, the controller 100 operates the FAD 45 by closing the FAD 45 when harmful pollutants are detected. For example, when the controller 100 detects a certain level of particulate matters in the outside air is beyond a threshold (e.g., AQI above 50) and/or that certain types of gases (e.g., CO, NO₂, SO₂ etc.) are present in the outside air is beyond a threshold (e.g., above 70 ppm for CO, above 20 ppm for NO₂, above 100 ppm for SO₂), the controller 100 sends a signal to close the FAD 45, thus preventing outside air from entering the building. This enables the harmful air pollutants from entering the dwelling spaces.

Referring back to FIG. 1, the controller 100 further includes a time delay relay 60, which sits in line with the damper control and is attached to the microcontroller 100. This dictates the opening of the circuit via an analog trigger line of code. In one implementation, when the programmed threshold is reached from the particulate sensor 20 and/or the gas detector 30, the controller 100 will send an analog signal to the delay relay 60 to open the connection to the FAD 45, which interrupts power for a set number of minutes on the relay 60 itself. The controller 100 may also control a step-down inverter 70. In one implementation, the step-down inverter 70 converts 24V AC to 120V DC. The step-down inverter 70 allows the voltage to be converted from AC to DC current for the components to function under a proper load and voltage. This is powered directly from a transformer 80 to convert the voltage that moves from a circuit board of the controller 100 to the AC unit. This process allows the AC and the component (e.g.; FAD 45) to work together while cycling on and off. Electricity usage can be increased or decreased depending on the power need. In one implementation, the transformer 80 converts voltage from 120V AC to 24V AC.

It should be appreciated that the controller 100 can further be responsive with other components, such as, but not limited to, a humidity sensor, a temperature sensor, and a liquid sensor. For example, when the controller 100 detects a certain temperature of the outside air is beyond a threshold temperature and/or or that a humidity of the outside air is also beyond a threshold humidity, the controller 100 sends a command to close the FAD, thus preventing outside air from entering the building. As such, this enables the function of heating and cooling of the HVAC system to operate more efficiently.

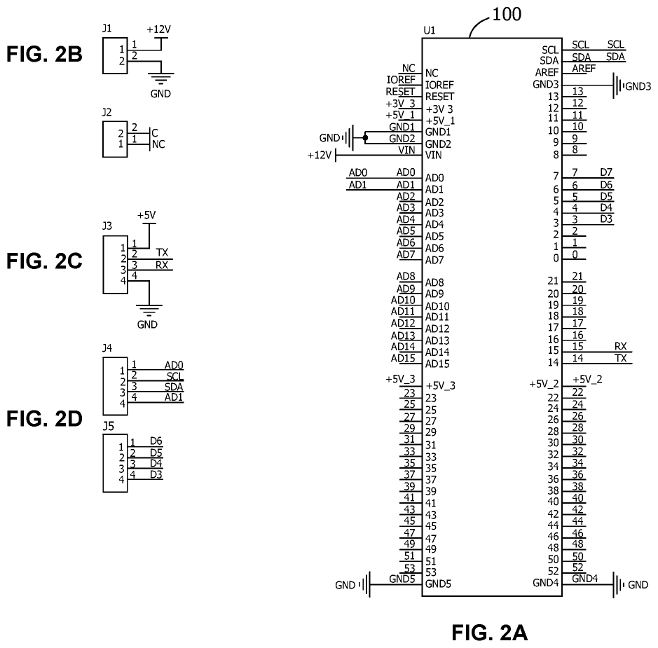

FIG. 2A depicts a controller 100 with numerous terminals for communications with components. As shown, there are 4 components, such as, for example, the particulate sensor 20, the gas sensor 30, the time-delay relay 60, and the inverter 70, in communication with the controller 100. It should be appreciated that even though there are only 4 different components shown, the board used in this design is capable of integrating a wide variety of components for prototyping.

FIGS. 2B-2D depict terminal blocks of the controller 100 to streamline the wiring of each component going to the controller 100.

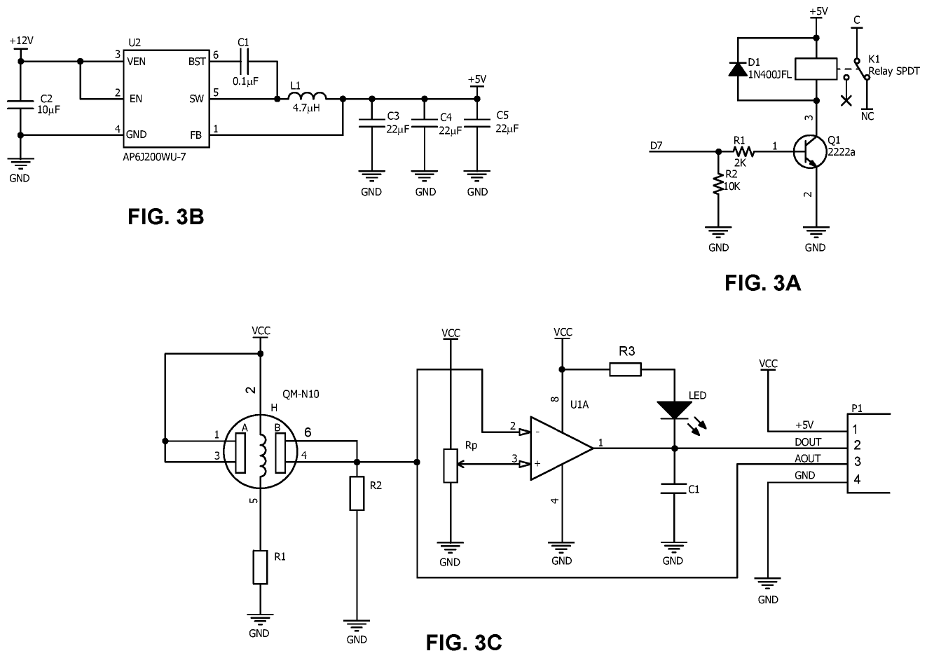

FIG. 3A depicts a schematic of the time delay relay 60 circuitry. The time delay relay 60 is configured to act as a power interrupt to close damper/economizer control 40 until the relay's 60 timed setpoint has expired.

FIG. 3B depicts a schematic of the particulate sensor component 20. In some implementations, the particulate sensor 20 is configured detects 2.5-10.0 parts per million (PPM) in the atmosphere. When detected, a digital signal is sent to the controller 100 to interrupt power to the damper/economizer 45.

FIG. 3C depicts a schematic of the gas detecting sensor component 20. In some implementations, the gas detecting sensor 20 detects gases that are hazardous to the human body and environment along with Volatile Organic Compounds (VOC) When detected, a digital signal is sent to the controller 100 to interrupt power to the damper/economizer 45.

In some implementations, the inverter 70 acts as an AC to DC current converter (e.g., 24V AC to 12V DC). This is powered directly from the step-down transformer 80 (e.g., 120V AC to 24V AC).

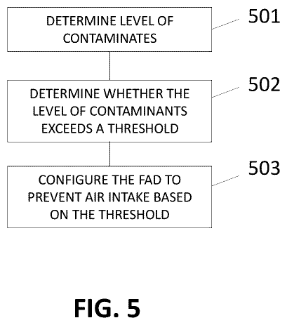

FIG. 5 is a flowchart of another example method for controlling air quality of an HVAC system, according to an example embodiment of the present disclosure. In step 501, the controller 100 is configured to determine level of contaminates, i.e., smoke, dust, dirt, soot, pollen, mold. In one implementation, the level is determining content of air between 2.5 to 10 ppm. In other implementations, the level is determining the type of gases present in the air, such as, the presence of carbon monoxide (CO), nitrogen dioxide (NO₂), sulfur dioxide (SO₂). Then, in step 502, the controller 100 is configured to determine the level of contaminants exceeds a threshold. In one implementation, the threshold can be AQI above 50. In other implementations, the threshold can be presence of CO above 70 ppm, NO₂ above 20 ppm, and/or SO₂ above 100 ppm. Next, in step 503, based on the threshold via the particulate sensor 20 and the gas sensor 30, the controller 100 operates the FAD 45 by closing the FAD 45 when the thresholds are exceeded.

The articles “a” and “an,” as used herein, mean one or more when applied to any feature in embodiments of the present disclosure described in the specification and claims. The use of “a” and “an” does not limit the meaning to a single feature unless such a limit is specifically stated. The article “the” preceding singular or plural nouns or noun phrases denotes a particular specified feature or particular specified features and may have a singular or plural connotation depending upon the context in which it is used. The adjective “any” means one, some, or all indiscriminately of whatever quantity.

“At least one,” as used herein, means one or more and thus includes individual components as well as mixtures/combinations.

The transitional terms “comprising”, “consisting essentially of” and “consisting of”, when used in the appended claims, in original and amended form, define the claim scope with respect to what unrecited additional claim elements or steps, if any, are excluded from the scope of the claim(s). The term “comprising” is intended to be inclusive or open-ended and does not exclude any additional, unrecited element, method, step or material. The term “consisting of” excludes any element, step or material other than those specified in the claim and, in the latter instance, impurities ordinarily associated with the specified material(s). The term “consisting essentially of” limits the scope of a claim to the specified elements, steps or material(s) and those that do not materially affect the basic and novel characteristic(s) of the claimed disclosure. All materials and methods described herein that embody the present disclosure can, in alternate embodiments, be more specifically defined by any of the transitional terms “comprising,” “consisting essentially of,” and “consisting of.”

Although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that, if an element is referred to as being “connected” or “coupled” to another element, it can be directly connected, or coupled, to the other element or intervening elements may be present. In contrast, if an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

Spatially relative terms (e.g., “beneath,” “below,” “lower,” “above,” “upper” and the like) may be used herein for ease of description to describe one element or a relationship between a feature and another element or feature as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, for example, the term “below” can encompass both an orientation that is above, as well as, below. The device may be otherwise oriented (rotated 90 degrees or viewed or referenced at other orientations) and the spatially relative descriptors used herein should be interpreted accordingly.

Example embodiments are described herein with reference to cross-sectional illustrations that are schematic illustrations of idealized embodiments (and intermediate structures). As such, variations from the shapes of the illustrations as a result, for example, of manufacturing techniques and/or tolerances, may be expected. Thus, example embodiments should not be construed as limited to the particular shapes of regions illustrated herein but may include deviations in shapes that result, for example, from manufacturing.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

While the disclosure has been described with reference to a preferred embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed:

1. An air quality control system for an HVAC system, comprising:
a particulate matter sensor for sensing particulates of outside air entering a building;
a gas matter sensor for sensing a concentration level of certain types of gases present in the outside air;
a fresh air damper configured to operate based on at least one of the particulate matter sensor or the gas matter sensor; and
a controller communicatively coupled to the particulate matter sensor, the gas matter sensor and the fresh air damper, wherein the controller is configured to:
receive information associated with a level of particulates of the outside air from the particulate matter sensor,
receive information associate with a level of concentration level of certain types of gases from the gas matter sensor, and
generate a damper command to close the fresh air damper, wherein the damper command is based on at least one of the level of particulates or the level of concentration level of certain types of gases.

2. The system of claim 1, wherein the fresh air damper is configured to be closed for a predetermined time until a quality of outside air is below a threshold.

3. The system of claim 2, wherein the threshold is an air quality index (AQI) below 100.

4. The system of claim 2, wherein the threshold is an air quality index (AQI) below 50.

5. The system of claim 2, wherein the threshold relates to at least one of an air quality index (AQI) value, a pollen count, a smog alert level, an air pollutant concentration, a humidity percentage, a dew point, a wind speed, or a precipitation percentage.

6. The system of claim 1, wherein the particulate matter sensor is a laser diode particulate sensor that uses laser scattering to radiate suspending particles in the air.

7. The system of claim 1, wherein the gas matter sensor includes a heated diode.

8. The system of claim 1, wherein the level of particulates is 2.5 to 10 ppm.

9. The system of claim 1, wherein the certain types of gases includes at least one of carbon monoxide (CO), nitrogen dioxide (NO₂), sulfur dioxide (SO₂), propane (C₃H₈), nitric oxide (NO) and various Volatile Organic Compounds (VOC)s.

10. A method of controlling air quality of an HVAC system, comprising:
determining, via a particulate matter sensor, information associated with a level of particulates of outside air;
determining, via a gas matter sensor, information associate with a level of concentration level of certain types of gases; and
generating a damper command to close a fresh air damper, wherein the damper command is based on at least the level of particulates or the level of concentration level of certain types of gases.

11. The method of claim 10, wherein the fresh air damper is configured to be closed for a predetermined time until a quality of outside air is below a threshold.

12. The method of claim 11, wherein the threshold is an air quality index (AQI) below 100.

13. The method of claim 11, wherein the threshold is an air quality index (AQI) below 50.

14. The method of claim 11, wherein the threshold relates to at least one of an air quality index (AQI) value, a pollen count, a smog alert level, an air pollutant concentration, a humidity percentage, a dew point, a wind speed, or a precipitation percentage.

15. The method of claim 10, wherein the level of particulates is 2.5 to 10 ppm.

16. The method of claim 10, wherein the certain types of gases include at least one of carbon monoxide (CO), nitrogen dioxide (NO₂), sulfur dioxide (SO₂), propane (C₃H₈), nitric oxide (NO) and various Volatile Organic Compounds (VOC)s.

17. A method of controlling air quality of an HVAC system, comprising:
determining a level of contaminates present in outside air;
determining whether the level of contaminates exceeds a threshold; and
in response to determining that the level of the contaminates exceeds the threshold, closing a fresh air damper to prevent air intake of the outside air from entering the HVAC system.

18. The method of claim 17, wherein the contaminant is one or more of a solid, a gas, and a liquid contaminant; and
the controller further determines the level of the contaminant by performing one or more of:
determining a first level of a solid contaminant;
determining a second level of a gaseous contaminant; and
determining a third level of a liquid contaminant.

19. The method of claim 18, wherein:
the first level is associated with particulate matters of 2.5-10 ppm,
the second level is associated with presence of at least one of carbon monoxide (CO), nitrogen dioxide (NO₂), sulfur dioxide (SO₂), propane (C₃H₈), nitric oxide (NO) and various Volatile Organic Compounds (VOC)s, and
the third level is associated with presence of humidity percentage.

20. The method of claim 17, further comprising an air contamination sensor to measure an internal level of contamination within the HVAC system.
